(19) United States
(12) Patent Application Publication
(10) Pub. No.: US 2024/0104541 A1
(43) Pub. Date: Mar. 28, 2024

(54) MONITORING DEVICE, PAYMENT SYSTEM INCLUDING A MONITORING DEVICE, AND CONTROL METHOD FOR A MONITORING DEVICE

(71) Applicant: Toshiba Tec Kabushiki Kaisha, Tokyo (JP)

(72) Inventor: Kota SUZUKI, Izunokuni Shizuoka (JP)

(21) Appl. No.: 18/357,612

(22) Filed: Jul. 24, 2023

(30) Foreign Application Priority Data
Sep. 26, 2022 (JP) 2022-152917

(51) Int. Cl. G06Q 20/20; A47F 9/04; G07G 1/00

(52) U.S. Cl. CPC G06Q 20/208; A47F 9/04; G07G 1/0036

(57) ABSTRACT

In accordance with an embodiment, a monitoring device acquires image data of an image of an imaging area including at least a placement portion for placing a purchased product of a payment apparatus including the placement portion. The monitoring device detects an article placed on the placement portion on the basis of the acquired image data, and measures a time period during which the detected article is left in the same place. The monitoring device notifies, where the measured time period exceeds a threshold value, that there is a lost article.

### CROSS-REFERENCE TO RELATED APPLICATIONS

This application is based upon and claims the benefit of priority from the prior Japanese Patent Application No. 2022-152917, filed on Sep. 26, 2022, the entire contents of which are incorporated herein by reference.

### FIELD

An embodiment to be described here generally relates to a monitoring device, a payment system including a monitoring device, and a control method for a monitoring device.

### BACKGROUND

In recent years, in retile stores such as supermarkets, attention has been focused on a self-service point of sales (POS) terminal from the viewpoint of reducing labor costs, infection prevention measures for infectious diseases, and the like. The self-service POS terminal is a full self-service payment apparatus in which customers perform operations from registration of purchased products to payment by themselves. In such a full self-service payment apparatus, a technology capable of preventing customer fraud has been developed.

Meanwhile, in the full self-service payment apparatus, new problems have arisen due to customers having to operate the payment apparatus by themselves. One of the problems is a problem of lost articles. When a customer operates the payment apparatus, there is a possibility that personal belongings (an umbrella, a bag, a wallet, and the like) or registered products are temporarily placed at an arbitrary position on the payment apparatus and then left behind. In the case where such a lost article is left in the payment apparatus, an employee (attendant) needs to promptly collect the lost article but is often unaware of the lost article.

### BRIEF DESCRIPTION OF THE DRAWINGS

FIG. 1 is a schematic configuration diagram showing a payment system according to an embodiment.

FIG. 2 is a schematic diagram showing an external configuration of a self-service POS terminal according to the embodiment.

FIG. 3 is a block diagram showing a circuit configuration of a main part of a monitoring device according to the embodiment.

FIG. 4 is a schematic diagram showing a data structure of a first table and a second table according to the embodiment.

FIG. 5 is a schematic diagram showing an example of an image taken by a camera according to the embodiment.

FIG. 6 is a schematic diagram showing a configuration necessary for realizing a fraudulent action monitoring function according to the embodiment.

FIG. 7 is a schematic diagram showing a configuration necessary for realizing a lost article monitoring function according to the embodiment.

FIG. 8 is a flowchart showing a main part of information processing executed by a processor according to the embodiment in accordance with a fraudulent action monitoring program.

FIG. 9 is a flowchart showing a main part of information processing executed by the processor according to the embodiment in accordance with a lost article monitoring program.

FIG. 10 is a flowchart showing a main procedure of information processing executed by the processor according to the embodiment in accordance with the lost article monitoring program.

FIG. 11 is a flowchart showing a main part of information processing executed by the processor according to the embodiment in accordance with the lost article monitoring program.

FIG. 12 is a schematic diagram showing an example of a screen displayed on a display device of an attendant terminal according to the embodiment.

### DETAILED DESCRIPTION

In accordance with an embodiment, a monitoring device monitors a payment apparatus including a placement portion for placing a purchased product. The monitoring device includes a camera interface, an image memory, and a processor. The camera interface is connected to a camera and captures image data of an image taken by the camera, the camera imaging an imaging area including the placement portion. The image memory stores the image data captured by the camera interface in chronological order. The processor is configured to acquire the image data stored in the image memory. The processor is further configured to detect an article placed on the placement portion on the basis of the acquired image data. The processor is further configured to measure a time period during which the detected article is left in the same place. The processor is further configured to notify, where the measured time period exceeds a threshold value, that there is a lost article in the placement portion.

A payment system that includes a monitoring device capable of monitoring the occurrence of a lost article in a full self-service payment apparatus according to an embodiment will be described below with reference to the drawings. In the drawings, the same reference symbols denote the same or similar portions.

[Description of Payment System]

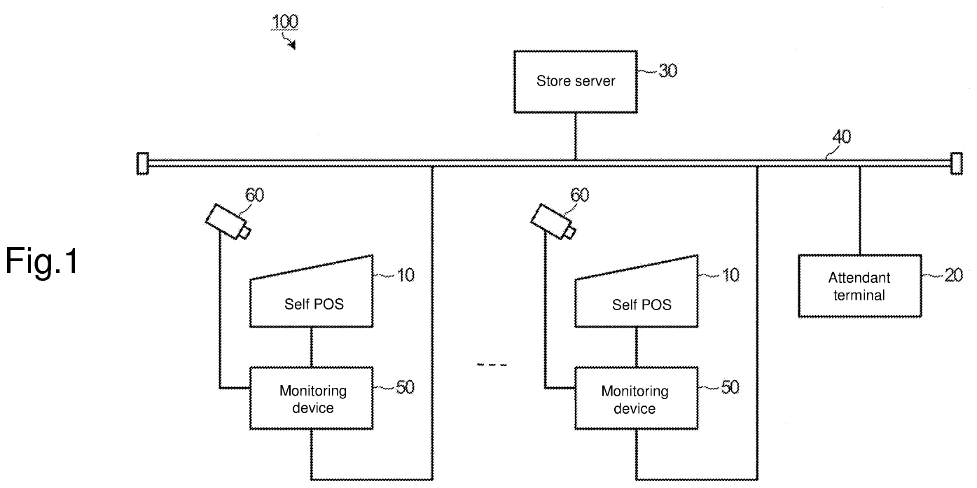

FIG. 1 is a schematic configuration diagram showing a payment system 100 according to this embodiment. The payment system 100 includes a plurality of self-service POS terminals 10, an attendant terminal 20, and a store server 30. In the payment system 100, each of the self-service POS terminals 10, the attendant terminal 20, and the store server 30 are connected to each other via a communication network 40 such as a local area network (LAN).

Each of the plurality of self-service POS terminals 10 is installed at the checkout counter of a store, and a customer who finished shopping is an operator of the self-service POS terminal 10. A customer who put a purchased product in a shopping basket or the like or put a purchased product in a shopping cart at the sales floor where products are displayed and moved to the checkout counter operates the self-service POS terminal 10 to pay for the purchased product, i.e., perform settlement relating to a transaction from registration of the product to the payment by self-service. The self-service POS terminal 10 is an example of a full self-service payment apparatus. The payment apparatus can be called a payment terminal, an account apparatus, an account terminal, a product registration apparatus, a product registration terminal, or the like.

The attendant terminal 20 is installed at the monitoring place provided in the vicinity of the exit of the checkout counter. The attendant terminal 20 displays, on a display device, a list of purchased products registered for each of the self-service POS terminals 10, or the like. Further, when an error has occurred in the self-service POS terminal 10, the attendant terminal 20 notifies information regarding the error. An employee in the monitoring place, a so-called attendant, monitors the checkout counter on the basis of the information displayed on the attendant terminal 20 or the notified information. Note that although the number of attendant terminals 20 is one in FIG. 1, a plurality of attendant terminals 20 may be connected to the communication network 40. Further, at least one of the attendant terminals 20 may be installed in a place different from the monitoring place, such as another floor of the same store like a back office and a help desk. Such an attendant terminal 20 located far away from the self-service POS terminal 10 can also notify error information from the self-service POS terminal 10 via the communication network 40. Therefore, even an employee who is in a place where he/she cannot directly see the self-service POS terminal 10 can monitor the self-service POS terminal 10.

The store server 30 provides various services according to the payment system 100 to the self-service POS terminals 10 and the attendant terminal 20 connected via the communication network 40. For example, the store server 30 manages a product database. The product database is a collection of product records created for each product stored in a store. The product record includes data such as a product code, a product name, and a price. The product code is a unique code set for each product in order to individually identify each product. To each product, a barcode representing the product code of the product is attached. The product name and the price are respectively a unique name of the product identified by the product code and the sales amount per product. The store server 30 searches, when a product code is input in the self-service POS terminal 10, the product database and provides data such as a product name and a price of the product record including the product code to the self-service POS terminal 10.

Each of the self-service POS terminals 10 includes a monitoring device 50. The monitoring device 50 may be provided outside the self-service POS terminal 10 or inside the self-service POS terminal 10. Each of the monitoring devices 50 is connected to the attendant terminal 20 via the communication network 40. Each of the monitoring devices 50 may be connected to the attendant terminal 20 not via the communication network 40.

The monitoring device 50 is a device that has a function of monitoring a fraudulent action of a customer who operates the self-service POS terminal 10, a so-called payer, and the occurrence of a thing left behind or a lost article. The monitoring device 50 is connected to a camera 60 provided in the vicinity of the self-service POS terminal 10. The monitoring device 50 monitors a fraudulent action of a payer on the self-service POS terminal 10 and monitors the occurrence of a lost article on the basis of information such as an image taken by the camera 60. In the case where the fraudulent action of a payer has been detected, the monitoring device 50 issues a warning. The fraudulent action is, for example, an action of packing a purchased product into a bag without registering the product in the self-service POS terminal 10. The fraudulent action is, for example, an action of leaving the checkout counter without paying for the purchased product. The warning is issued to one or both of the self-service POS terminal 10 and the attendant terminal 20. In the case where a lost article has been detected, the monitoring device 50 notifies that there is a lost article. The notification is made to the attendant terminal. The notification may be made to both the self-service POS terminal 10 and the attendant terminal 20.

[Description of Self-Service POS Terminal]

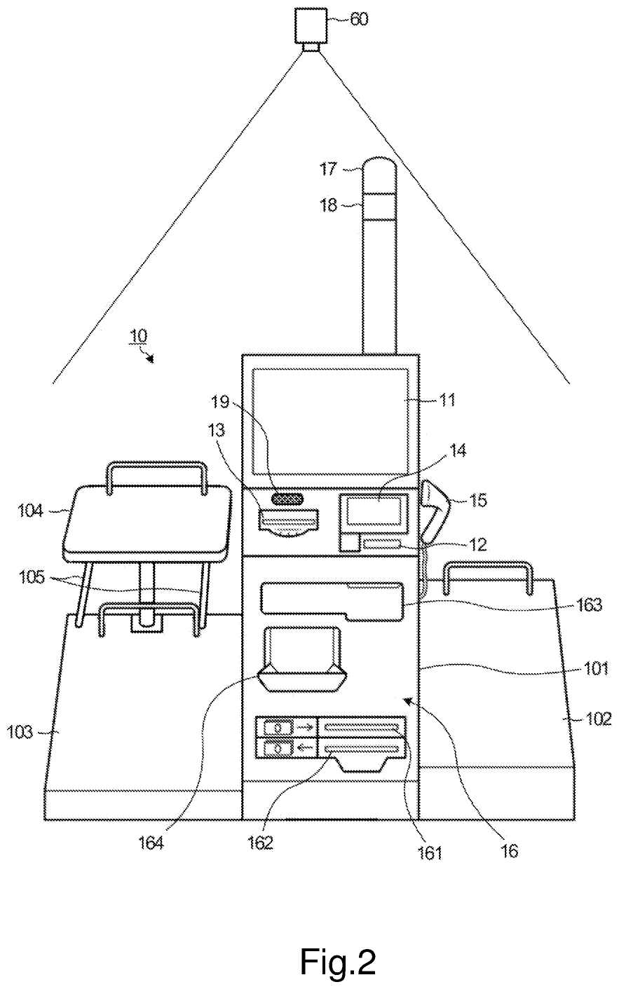

FIG. 2 is a schematic diagram showing an external configuration of the self-service POS terminal 10. The self-service POS terminal 10 includes a body 101, a first product placement table 102, and a second product placement table 103, the first product placement table 102 and the second product placement table 103 being disposed on the right and left side of the body 101, respectively. The first product placement table 102 disposed on the right side of the body 101 is a table for a customer who is a payer to place a purchased product before registration. The purchased product before registration is usually put in a shopping basket and placed on the first product placement table 102. The purchased product before registration may be disposed in front or above the first product placement table 102 while being loaded in a shopping cart.

The second product placement table 103 disposed on the left side of the body 101 is a table for the payer to place the purchased product after registration. The purchased product after registration is put in a container placed on the second product placement table 103, e.g., a shopping basket, a shopping bag, or my own bag. The purchased product after registration may be directly placed on the second product placement table 103. In FIG. 2, a temporary stand 104 is provided via a support above the second product placement table 103. The temporary stand 104 is a stand for temporarily placing, for example, a product before putting the product in a shopping bag or the like. Two holding arms 105 are provided to the temporary stand 104 to be horizontally spaced apart from each other. The payer can place the shopping bag, my own bag, or the like on the second product placement table 103 while the shopping bag, my own bag, or the like is opened, by using these holding arms 105.

As described above, each of the first product placement table 102 and the second product placement table 103 functions as a placement portion for placing a purchased product. Note that the installation positions of the first product placement table 102 and the second product placement table 103 may be reversed right and left.

The body 101 includes a touch panel 11 serving as an input/output device, a card reader 12, a printer 13, a scanner 14, a hand scanner 15, a cash handling machine 16, a patrol lamp 17, a light-emitting unit 18, a speaker 19, and the like.

The touch panel 11 includes a display serving as a display device and a touch sensor serving as an input device. The display displays various types of screen information such as a payment start screen, a product registration screen, a payment method selection screen, and a payment end screen. The payment start screen is a screen for receiving the payment start of a transaction. A start key for commanding the payment start of a transaction is disposed on the payment start screen. A payer who starts registering a purchased product touches the start key. When the touch sensor detects that the start key has been touched, the controller of the self-service POS terminal 10 switches the screen of the display from the payment start screen to the product registration screen.

The product registration screen is a screen for displaying item information such as the product name, the price, and the total amount of the purchased products that have been registered. A payment key for commanding transition to payment for the purchased products that have been registered is disposed on the product registration screen. The payer who has registered the purchased products touches the payment key. When the touch sensor detects that the payment key has been touched, the controller of the self-service POS terminal 10 switches the screen of the display from the product registration screen to the payment method selection screen.

The payment method selection screen is a screen for receiving a selection input of a payment method such as cash payment, credit card payment, electronic money payment, and code payment. A cash key for commanding cash payment, a credit key for commanding credit card payment, an electronic money key for commanding electronic money payment, a code payment key for commanding code payment, and the like are disposed on the payment method selection screen. The payer touches the key of a desired payment method. For example, when the touch sensor detects that the cash key has been touched, the controller of the self-service POS terminal 10 executes payment processing by cash and switches the screen of the display from the payment method selection screen to the payment end screen by cash. When the touch sensor detects that the credit key has been touched, the controller of the self-service POS terminal 10 executes payment processing by credit card and switches the screen of the display from the payment method selection screen to the payment end screen by credit card. When the touch sensor detects that the electronic money key has been touched, the controller of the self-service POS terminal 10 executes payment processing by electronic money card and switches the screen of the display from the payment method selection screen to the payment end screen by electronic money card. When the touch sensor detects that the code payment key has been touched, the controller of the self-service POS terminal 10 executes payment processing by code for code payment and switches the screen of the display from the payment method selection screen to the payment end screen by code payment.

For example, the payment end screen by cash is a screen for displaying the total amount of the transaction, the amount of money deposited in cash, the change amount, and the like. For example, the payment processing by cash is processing of subtracting the total amount of the transaction from the deposit amount to calculate the change amount and issuing a receipt to finish the transaction. Since such payment processing by cash is well-known processing, detailed description thereof is omitted. Further, since the payment processing by credit card, electronic money card, or code payment is also well-known processing, description thereof is omitted.

The card reader 12 is a device that reads data recorded in a card medium such as a credit card, an electronic money card, and a rewards card. In the case where the card medium is a magnetic card, the card reader 12 is a magnetic card reader. In the case where the card medium is an IC card, the card reader 12 is an IC card reader. The self-service POS terminal 10 may include one or both of the magnetic card reader and the IC card reader as the card reader 12. The card reader 12 may be a card reader/writer having a function of writing data to a card.

The printer 13 is a device that prints data regarding a purchase receipt, a credit card slip, or the like on receipt paper. The receipt paper on which various types of data have been printed by the printer 13 is cut by a cutter and issued from a receipt outlet. The printer 13 is realized by, for example, a thermal printer or a dot impact printer.

The scanner 14 and the hand scanner 15 read information for identifying a product. In this embodiment, the scanner 14 and the hand scanner 15 reads, information for identifying a product, the barcode attached to the product. The scanner 14 optically reads the barcode of the product held over the reading window (glass window) such that the barcode attached to the product faces the reading window. The hand scanner 15 is operated by a payer by hand and is brought close to the barcode attached to the product, thereby optically reading the barcode. Note that the scanner 14 and the hand scanner 15 only need to read information for recognizing a product and may read information other than a barcode, such as a two-dimensional code.

The cash handling machine 16 handles cash. The cash handling machine 16 includes a bill insertion slot 161, a bill ejection slot 162, a coin insertion slot 163, and a coin ejection slot 164. The cash handling machine 16 handles a bill inserted into the bill insertion slot 161. The cash handling machine 16 ejects a bill as change from the bill ejection slot 162. The cash handling machine 16 receives and handles a coin inserted into the coin insertion slot 163. The cash handling machine 16 ejects a coin as change from the coin ejection slot 164.

The patrol lamp 17 is mounted at the tip of the pole extending in the vertical direction such that it can be seen from a distance. The patrol lamp 17 includes a light-emitting member and a cylinder. The light-emitting member is rotatably mounted inside the cylinder coaxially with the cylinder. When the patrol lamp 17 operates, it can be caused to rotate while causing the light-emitting member to emit light. The patrol lamp 17 is for displaying an alert. For example, the patrol lamp 17 turns on the light-emitting member when registering a product to allow a payer or an employee near the attendant terminal 20 to visually check whether or not the product is appropriately scanned.

The light-emitting unit 18 is disposed below the patrol lamp 17 of the pole. Similarly to the patrol lamp 17, the light-emitting unit 18 also includes a light-emitting member and a cylinder. The light-emitting member is capable of selectively emitting light in a plurality of colors. Alternatively, the light-emitting unit 18 includes a plurality of light-emitting members with different emission colors. Similarly to the patrol lamp 17, the light-emitting unit 18 is also for displaying an alert. The light-emitting unit 18 is capable of displaying an alert such as an error and detection of a fraudulent action of a payer by the emission color of the light-emitting member or the emission color and the blinking state.

The speaker 19 outputs a sound such as a warning sound as an alert and a voice as a message.

The camera 60 serving as an imaging apparatus is mounted above the body 101. The camera 60 images the self-service POS terminal 10 and a payer who operates the self-service POS terminal 10. As shown in FIG. 2, the display of the touch panel 11, the card insertion port of the card reader 12, the receipt outlet of the printer 13, the reading window of the scanner 14, and the bill insertion slot 161, the bill ejection slot 162, the coin insertion slot 163, and the coin ejection slot 164 of the cash handling machine 16 are disposed on one surface of the body 101 (hereinafter, referred to as a “front surface”). For this reason, the payer stands facing the front surface of the body 101 and operates the self-service POS terminal 10. The camera 60 images the self-service POS terminal 10 and the payer standing in front of the self-service POS terminal 10 from above. Therefore, the head, face, shoulders, arms, chest, abdomen, and the like of the payer are imaged by the camera 60. Further, the upper surface of the self-service POS terminal 10 including the first product placement table 102 and the second product placement table 103 disposed on the right and left sides of the body 101 is also imaged by the camera 60.

[Description of Configuration of Monitoring Device]

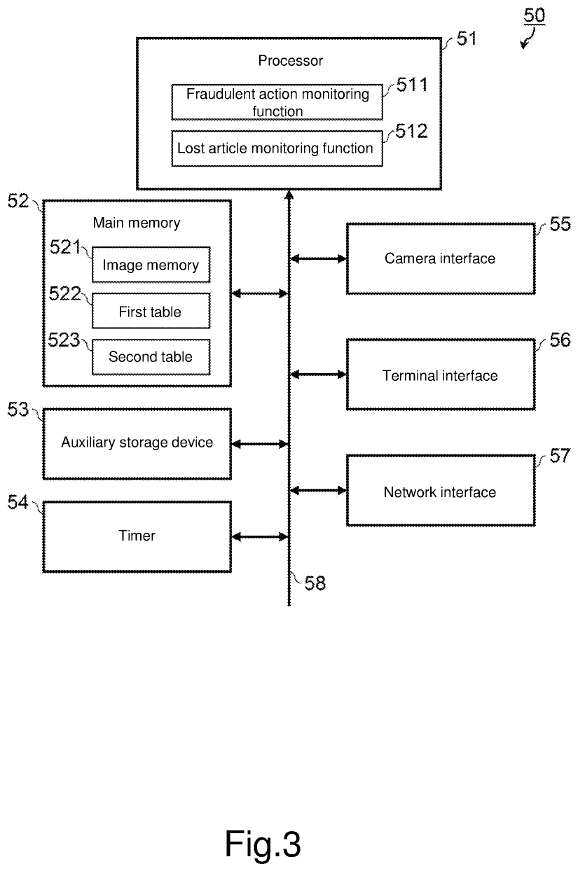

FIG. 3 is a block diagram showing a circuit configuration of a main part of the monitoring device 50. The monitoring device 50 includes a processor 51, a main memory 52, an auxiliary storage device 53, a timer 54, a camera interface 55, a terminal interface 56, a network interface 57, a system transmission path 58, and the like. The system transmission path 58 includes an address bus, a data bus, a control signal line, and the like. The system transmission path 58 connects the processor 51 to respective other units and transmits data signals transmitted/received to/from each other.

The monitoring device 50 connects the processor 51, the main memory 52, the auxiliary storage device 53, the timer 54, the camera interface 55, the terminal interface 56, and the network interface 57 to each other via the system transmission path 58 to constitute a computer.

The processor 51 corresponds to the brain of the computer. The processor 51 controls the respective units to realize various functions as the monitoring device 50 in accordance with an operating system or an application program. The processor 51 is, for example, a central processing unit (CPU). The processor 51 is a multi-core or multi-threaded processor capable of executing a plurality of types of processing in parallel.

The main memory 52 corresponds to the main memory of the computer. The main memory 52 has a non-volatile memory area and a volatile memory area. The main memory 52 stores an operating system or an application program in the non-volatile memory area. In the main memory 52, data necessary for the processor 51 to execute processing for controlling the respective units is stored in the non-volatile or volatile memory area in some cases. The processor 51 uses the volatile memory area of the main memory 52 as a work area where data is rewritten as appropriate. The non-volatile memory area is, for example, a read only memory (ROM). The volatile memory area is, for example, a random access memory (RAM).

The auxiliary storage device 53 corresponds to the auxiliary memory of the computer. For example, an electric erasable programmable read-only memory (EEPROM), a hard disk drive (HDD), or a solid state drive (SSD) can be the auxiliary storage device 53. The auxiliary storage device 53 stores data to be used by the processor 51 for performing various types of processing, data created by processing in the processor 51, and the like. The auxiliary storage device 53 stores the application program described above in some cases.

The timer 54 is a circuit that periodically outputs a timer interrupt signal. The timer interrupt signal is provided to the processor 51 through the system transmission path 58. In this embodiment, the timer 54 outputs a timer interrupt signal at one second intervals.

The camera 60 is connected to the camera interface 55. The camera interface 55 outputs a control signal for controlling the driving of the camera 60 to the camera 60. The camera 60 performs an imaging operation in accordance with this control signal. The camera interface 55 captures image data of an image taken by the camera 60.

The self-service POS terminal 10 is connected to the terminal interface 56. The terminal interface 56 performs data communication with the self-service POS terminal 10. The terminal interface 56 captures operation input data to the self-service POS terminal 10 by a payer, or the like. Examples of the operation input data include operation input data relating to payment start, operation input data relating to product registration, operation input data relating to payment declaration, and operation input data relating to payment end. The operation input data relating to payment start is data to be output in accordance with an operation of the start key of the payment start screen by a payer. The operation input data relating to product registration is data to be output in accordance with an operation of holding a barcode of a product over the reading window of the scanner 14 by a payer or an operation of holding the reading window of the hand scanner 15 over a barcode. The data includes data of a product record including a product code represented by the barcode scanned by the scanner 14 or the hand scanner 15. The operation input data relating to payment declaration is data to be output in accordance with an input of the payment key of the product registration screen by a payer. The operation input data relating to payment end is data to be output after payment processing by the payment method selected from the payment method selection screen is finished and the payment end screen is displayed. The operation input data relating to payment end is output after enough time has elapsed for a customer who has finished the payment to leave the self-service POS terminal 10. A motion detector that outputs a sensing signal during a payer is present within a sensing range on the front surface side of the self-service POS terminal 10 may be provided to the self-service POS terminal 10 and the operation input data relating to payment end may be output in accordance with loss of the sensing signal.

The attendant terminal 20 is connected to the network interface 57 via the communication network 40. The network interface 57 performs data communication with the attendant terminal 20.

The monitoring device 50 having such a configuration uses part of the volatile memory area in the main memory 52 as areas of an image memory 521, a first table 522, and a second table 523. The image memory 521 is an area for storing image data in units of frames captured via the camera interface 55 in chronological order. The first table 522 and the second table 523 are areas for storing data relating to an article detected from the image taken by the camera 60.

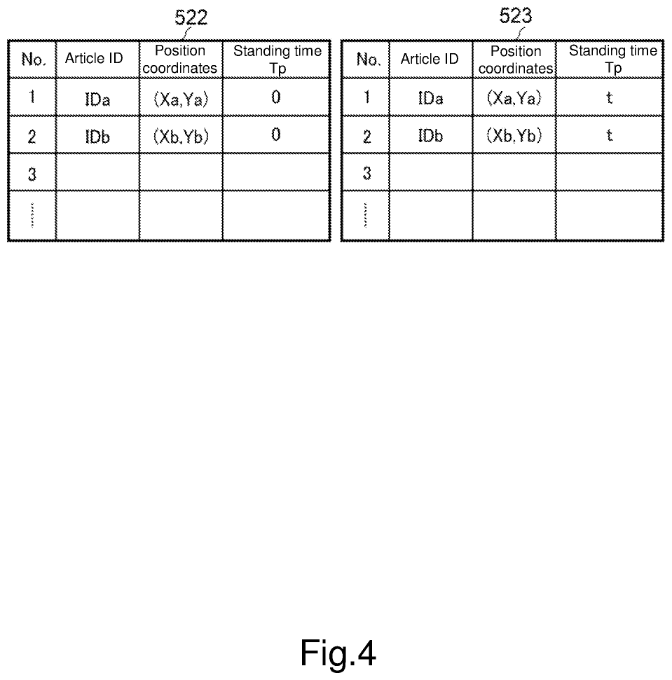

FIG. 4 is a schematic diagram showing a data structure of each of the first table 522 and the second table 523. The first table 522 and the second table 523 each include a column of a record number, a column of an article ID, a column of position information, and a column of a standing time. That is, the first table 522 and the second table 523 are each an area capable of storing a plurality of records including the record number, the article ID, the position information (position coordinates), and the standing time. In the column of a record number, a series of number starting with “1” is described as a record number. The article ID, the position information, and the standing time described in the other columns will be clarified in the description of a lost article monitoring function 512 described below.

Further, the monitoring device 50 stores the fraudulent action monitoring program and the lost article monitoring program so that the processor 51 has a fraudulent action monitoring function 511 and a lost article monitoring function 512. The fraudulent action monitoring program and the lost article monitoring program are each a type of application program stored in the main memory 52 or the auxiliary storage device 53. The method of installing the fraudulent action monitoring program and the lost article monitoring program in the main memory 52 or the auxiliary storage device 53 is not particularly limited. The fraudulent action monitoring program and the lost article monitoring program can be recorded on a removable recording medium or delivered through communication via a network and installed in the main memory 52 or the auxiliary storage device 53. The form of the recording medium does not matter as long as the recording medium can store a program like a CD-ROM, a memory card, or the like and can be read by a device.

[Description of Function of Monitoring Device]

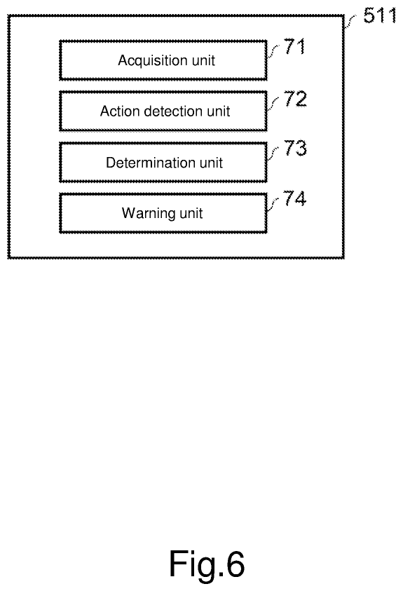

FIG. 6 a schematic diagram showing a configuration necessary for realizing the fraudulent action monitoring function 511. As shown in FIG. 6, the fraudulent action monitoring function 511 is realized by an acquisition unit 71, an action detection unit 72, a determination unit 73, and a warning unit 74. The acquisition unit 71 sequentially acquires the image in units of frames stored in the image memory 521 in chronological order. The action detection unit 72 detects an action of a payer from the image acquired by the acquisition unit 71. The determination unit 73 determines whether or not the action detected by the action detection unit 72 is a fraudulent action. The warning unit 74 issues a warning in the case where the determination unit 73 has determined that the action is a fraudulent action.

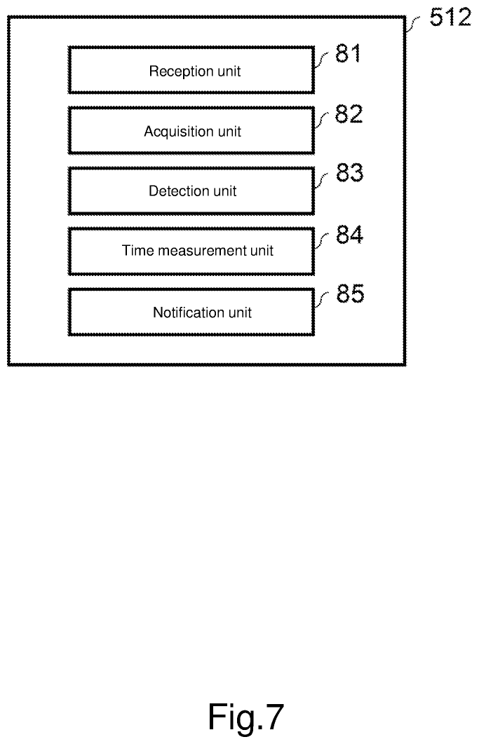

FIG. 7 is a schematic diagram showing a configuration necessary for realizing the lost article monitoring function 512. As shown in FIG. 7, the lost article monitoring function 512 is realized by a reception unit 81, an acquisition unit 82, a detection unit 83, a time measurement unit 84, and a notification unit 85. The reception unit 81 receives, from the self-service POS terminal 10, a payment end signal for notifying payment end of a purchased product. The operation input data relating to payment end input from the self-service POS terminal 10 to the terminal interface 56 can be the payment end signal. Further, the reception unit 81 receives, from the self-service POS terminal 10, a payment start signal for notifying payment start of a purchased product. The operation input data relating to payment start input from the self-service POS terminal 10 to the terminal interface 56 can be the payment start signal.

The acquisition unit 82 sequentially acquires the image in units of frames stored in the image memory 521 in chronological order. That is, the acquisition unit 82 acquires an image of an imaging area including at least a placement portion (the first product placement table 102 and the second product placement table 103) on which a purchased product is placed of a payment apparatus (self-service POS terminal 10) that includes the placement portion.

The detection unit 83 detects, on the basis of the image acquired by the acquisition unit 82, an article placed on the placement portion. The article is typically a product. The article is personal belongings (an umbrella, a bag, a wallet, and the like) of the payer or a shopping basket in some cases. The detection unit 83 starts an operation of detecting an article by using the payment end signal as a trigger. The detection unit 83 stops the detection operation in the case where an article has not been detected at the time point when the payment start signal was received. The detection unit 83 continues the detection operation in the case where an article has been detected at the time point when the payment start signal was received.

The time measurement unit 84 measures a time period during which the article detected by the detection unit 83 is left on the same place. Note that the detection unit 83 continues the detection operation in the case where an article has been detected at the time point when the payment start signal was received, as described above. At this time, the time measurement unit 84 measures a time period during which an article that has been detected immediately before the payment start signal was received is left on the same place. The time measurement unit 84 does not measure a time period for an article detected after the payment start signal was received.

The notification unit 85 notifies, when the time period measured by the time measurement unit 84 exceeds a threshold value, that there is a lost article. The threshold value is an arbitrary time period sufficient to specify the article left in the same place as a lost article. The notification unit 85 outputs a notification signal to the attendant terminal 20 to notify an attendant of that there is a lost article. The notification unit 85 may output a notification signal to the self-service POS terminal 10 to notify an operator of the self-service POS terminal 10, usually a customer, that there is a lost article.

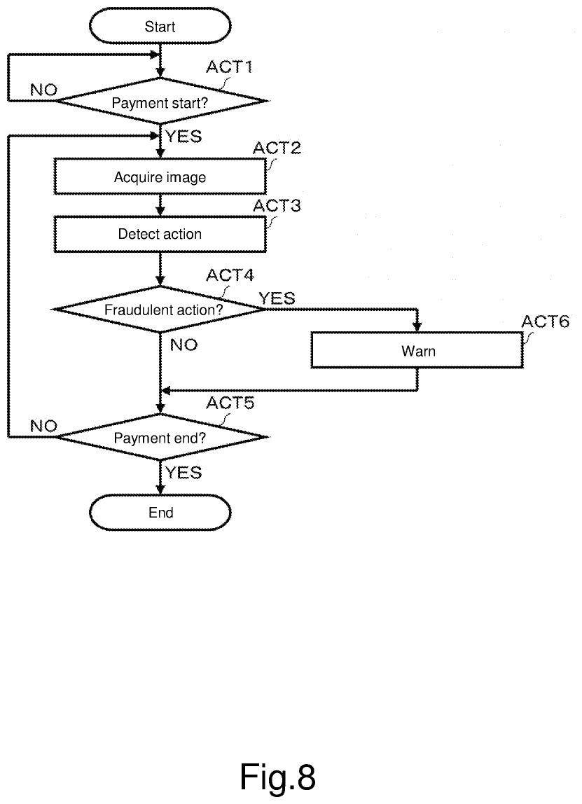

Next, details of the fraudulent action monitoring function 511 will be described with reference to the flowchart of FIG. 8. FIG. 8 is a flowchart showing a main part of information processing executed by the processor 51 in accordance with a fraudulent action monitoring program. Note that the procedure and content of the information processing described below are an example. The procedure and content can be appropriately changed as long as similar operations and effects can be exhibited.

In ACT1, the processor 51 being in an idle state stands by for a payment start signal. When operation input data relating to payment start is received from the self-service POS terminal 10 via the terminal interface 56 (YES in ACT1), the processing of the processor 51 proceeds to ACT2. In ACT2, the processor 51 acquires image data from the image memory 521. Since the image in units of frames data taken by the camera 60 is stored in the image memory 521 in chronological order, the processor 51 acquires image data of an image taken after receiving the operation input data relating to payment start.

In ACT3, the processor 51 that has acquired image data detects, on the basis of the image data, an action of a payer on the self-service POS terminal 10. Then, in ACT4, the processor 51 determines whether or not the action is a fraudulent action. In the case where the action is not a fraudulent action (NO in ACT4), the processing of the processor 51 proceeds to ACT5. In ACT5, the processor 51 checks whether or not a payment end signal has been received.

In the case where a payment end signal has not been received (NO in ACT5), the processing of the processor 51 returns to ACT2. That is, the processor 51 acquires the next image data from the image memory 521 in ACT2, detects the action of the payer in ACT3, and determines whether or not the action is a fraudulent action in ACT4.

For example, in the case where the action of the payer is an action of packing a purchased product into a bag without registering the product in the self-service POS terminal 10 or an action of leaving the checkout counter without paying for the purchased product, the processor 51 determines that the action of the payer is a fraudulent action (YES in ACT4). Then, the processing of the processor 51 proceeds to ACT6. In ACT6, the processor 51 issues a warning. The processor 51 outputs a warning signal to the self-service POS terminal 10 via the terminal interface 56. Alternatively, the processor 51 outputs a warning signal to the attendant terminal 20 via the network interface 57. Alternatively, the processor 51 may output a warning signal to both the self-service POS terminal 10 and the attendant terminal 20.

After the processor 51 issues a warning, the processing of the processor 51 proceeds to ACT5. In the case where a payment end signal has not been received (NO in ACT2), the processing of the processor 51 proceeds to ACT2. The processor 51 repeats processing of acquiring the next image data from the image memory 521 in ACT2, detecting the action of the payer in ACT3, and determining whether or not the action is a fraudulent action in ACT4.

When the operation input data relating to payment end is received from the self-service POS terminal 10 via the terminal interface 56 (YES in ACT5), the processor 51 finishes the information processing shown in the flowchart of FIG. 8 and returns to the idle state.

The processor 51 executes the function of the acquisition unit 71 by the processing of ACT2, the function of the action detection unit 72 by the processing of ACT3, the function of the determination unit 73 by the processing of ACT4, and the function of the warning unit 74 by the processing of ACT6. In this way, in the case where a fraudulent action of the payer who operates the self-service POS terminal 10 has been recognized, a warning signal is provided to the self-service POS terminal 10 or the attendant terminal 20. This warning signal causes the light-emitting unit 18 to emit light and the speaker 19 to issues a warning in the self-service POS terminal 10. In the attendant terminal 20, an attendant is notified of that a fraudulent action of the payer who operates the self-service POS terminal 10 has been recognized. As a result, a warning is issued in real time against the fraudulent action of the payer, and thus, the effect of preventing fraud can be achieved.

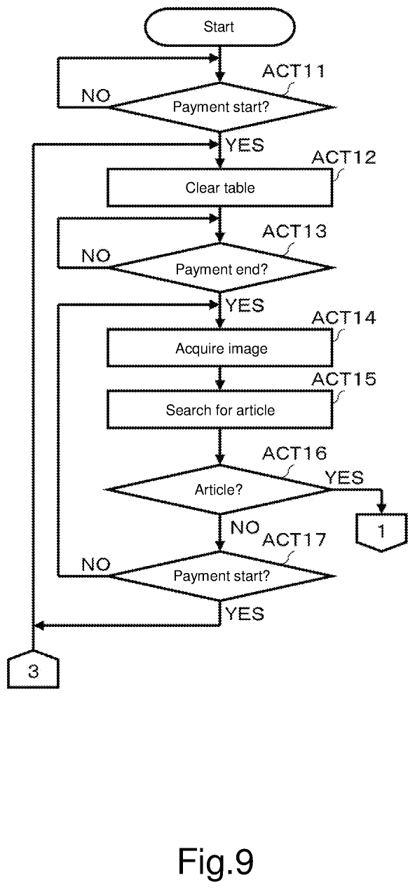

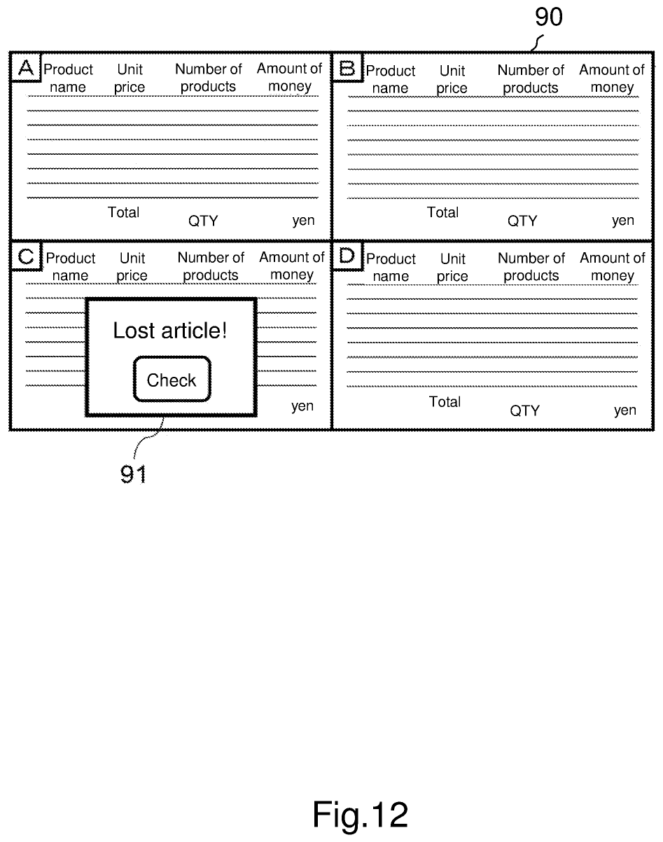

Next, details of the lost article monitoring function 512 will be described with reference to the flowcharts of FIG. 9 to FIG. 11 and the screen example of FIG. 12. FIG. 9 to FIG. 11 are each a flowchart showing a main part of information processing executed by the processor 51 in accordance with a lost article monitoring program. FIG. 12 is a schematic diagram showing a screen displayed on the display device of the attendant terminal 20. Note that the procedure and content of the information processing described below are an example. The procedure and content can be appropriately changed as long as similar operations and effects can be exhibited. Further, the screen of FIG. 12 is also an example. It goes without saying that the arrangement of display elements on the screen, the content of text, or the like can be changed as appropriate.

In ACT11, the processor 51 being in the idle state stands by for a payment start signal. When operation input data relating to payment start is received from the self-service POS terminal 10 via the terminal interface 56 (YES in ACT11), the processing of the processor 51 proceeds to ACT12. In ACT12, the processor 51 clears the first table 522 and the second table 523.

After that, in ACT13, the processor 51 stands by for a payment end signal. When operation input data relating to payment end is received from the self-service POS terminal 10 via the terminal interface 56 (Yes in ACT13), the processing of the processor 51 proceeds to ACT14. In ACT14, the processor 51 acquires image data from the image memory 521. Since the image in units of frames data taken by the camera 60 is stored in the image memory 521 in chronological order, the processor 51 acquires image data of an image taken after receiving the operation input data relating to payment end.

In ACT15, the processor 51 that has acquired image data analyzes the image data to search for an article placed on the first product placement table 102 or the second product placement table 103. For example, the processor 51 uses a known object recognition technology by pattern matching or deep learning to recognize the first product placement table 102 and the second product placement table 103 from the image and further recognize an article such as a product, personal belongings, and a shopping basket presumed to be placed on the first product placement table 102 or the second product placement table 103.

In ACT16, the processor 51 determines whether or not an article has been detected. In the case where an article has not been detected (NO in ACT16), the processing of the processor 51 proceeds to ACT17. In ACT17, the processor 51 checks whether or not a payment start signal has been received. In the case where a payment start signal has not been received (NO in ACT17), the processing of the processor 51 returns to ACT14. That is, the processor 51 acquires the next image data from the image memory 521 in ACT14, searches for an article in ACT15, and determines whether or not an article has been detected in ACT16.

As described above, the processor 51 that has received operation input data relating to payment end from the self-service POS terminal 10 repeatedly executes the processing of ACT14, ACT15, and ACT16 until operation input data relating to payment start is received from this self-service POS terminal 10. In the case where operation input data relating to payment start is received without detecting an article (YES in ACT17), the processing of the processor 51 returns to ACT12. That is, the processor 51 clears the first table 522 and the second table 523 and stands by for a payment end signal.

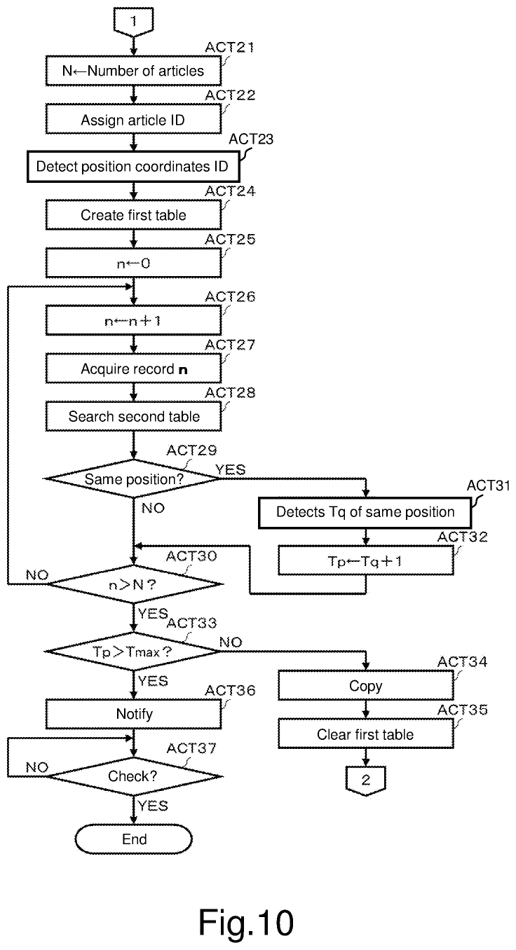

Meanwhile, in the case where an article placed on the first product placement table 102 or the second product placement table 103 has been detected from the image taken by the camera 60 (YES in ACT16), the processing of the processor 51 proceeds to ACT21 in FIG. 10. Incidentally, there are two events in which an article is detected. One of the events is a case where an article has been placed on the first product placement table 102 or the second product placement table 103 at the time point when operation input data relating to payment end was received. A case where a payer has left a product or personal belongings on the first product placement table 102 or the second product placement table 103 or has not put away an empty shopping basket from the first product placement table 102 corresponds to this event. The other event is a case where an article is placed on the first product placement table 102 or the second product placement table 103 after receiving operation input data relating to payment end. For example, a case where a child has placed a toy or the like on the first product placement table 102 or the second product placement table 103 and left it corresponds to the event. In either case, the processing of the processor 51 proceeds to ACT21.

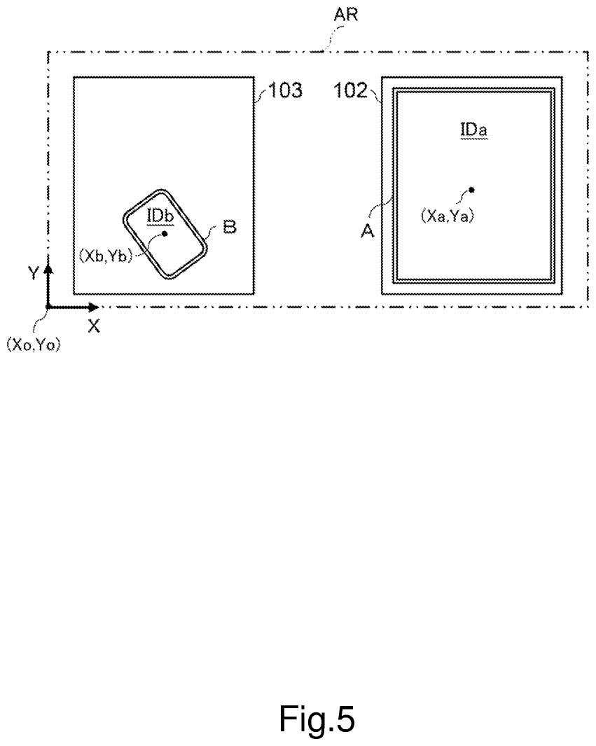

In ACT21, the processor 51 stores the number of articles “N”. The number of articles “N” is the total number of articles detected as being placed on the first product placement table 102 or the second product placement table 103 from the image. In ACT22, the processor 51 assigns unique article IDs to the respective articles for the number of articles “N”. Further, in ACT23, the processor 51 detects the central position coordinates of the respective articles for the number of articles “N”. Now, the processing of ACT22 and ACT23 will be specifically described with reference to FIG. 5.

FIG. 5 is a schematic diagram showing an example of an image “AR” taken by the camera 60. Note that display elements that are unnecessary for description are all omitted. The image “AR” shows the first product placement table 102 and the second product placement table 103. A first article “A” is placed on the first product placement table 102. A second article “B” is placed on the second product placement table 103. The first article “A” is an empty shopping basket. The second article “B” is a registered product. That is, assumption is made that a payer has not put away the shopping basket placed on the first product placement table 102 and left one purchased product on the second product placement table 103.

In the case where the image “AR” shown in FIG. 5 is acquired, the processor 51 assigns an article IDa to the first article “A” and an article IDb to the second article “B” in ACT22. Further, in ACT23, the processor 51 detects coordinates (Xa, Ya) of the central position of the first article “A” and coordinates (Xb, Yb) of the central position of the second article “B” in a two-dimensional place coordinate system with the origin (Xo, Yo) at the lower left corner of the image “AR”, for example.

When the processor 51 finishes the processing of ACT22 and ACT23, the processing of the processor 51 proceeds to ACT24. In ACT24, the processor 51 creates the first table 522. That is, the processor 51 describes the article ID and the position coordinates of each of the detected articles (the article “A” and the article “B”) to the column of an article ID and the column of position coordinates of the first table 522 in ascending order of the record number. Further, the processor 51 describes 0 second as the standing time “Tp” to the column of a standing time.

After the processor 51 finishes creating the first 522, the processing of the processor 51 proceeds to ACT25. In ACT25, the processor 51 resets the addition counter value “n” to “0”. The addition counter value “n” is contained in the processor 51. After that, in ACT26, the processor 51 counts up the addition counter value “n” by “1”. Then, in ACT27, the processor 51 acquires the record of a record number n from the first table 522. The “n” of the record number n is a count value of the addition counter value “n”. The record includes an article ID, position information, and a standing time “Tp”. Hereinafter, the record acquired in ACT27 will be referred to as a first record Rx.

In ACT28, the processor 51 that has acquired the first record Rx searches the second table 523. In ACT29, the processor 51 checks whether or not a record including position coordinates substantially matching the position coordinates of the first record Rx is stored in the second table 523. The phrase “substantially matching” means, for example, a case where the length of the line segment connecting a first point specified by one position coordinates and a second point specified by the other position coordinates is equal to or less than a predetermined distance. The predetermined distance is, for example, an arbitrary value of 1 cm or less. Hereinafter, a record including position coordinates substantially matching the position coordinates of the first record Rx will be referred to as a second record Ry.

In the case where the second record Ry is not stored in the second table 523 (NO in ACT29), the processing of the processor 51 proceeds to ACT30. In ACT30, the processor 51 determines whether or not the counter value “n” has exceeded the number of articles “N”. In the case where the counter value “n” has not exceeded the number of articles “N” (NO in ACT30), the processing of the processor 51 returns to ACT26.

That is, the processor 51 counts up the addition counter value “n” by “1” in ACT26, acquires the first record Rx from the first table 522 in ACT27, and searches the second table 523 in ACT28.

Initially, the second table 523 is cleared. Therefore, in ACT29, a record including position coordinates substantially matching the position coordinates of the first record Rx, i.e., the second record Ry, has never been stored in the second table 523. Therefore, the processor 51 repeats the processing of ACT26 to ACT30 until the counter value “n” exceeds the number of articles “N”.

When the counter value “n” exceeds the number of articles “N” (YES in ACT30), the processing of the processor 51 proceeds to ACT33. In ACT33, the processor 51 checks whether or not a record including a standing time “Tp” that has exceeded a threshold value Tmax is stored in the first table 522. The threshold value Tmax is, for example, an arbitrary value of “5” or more.

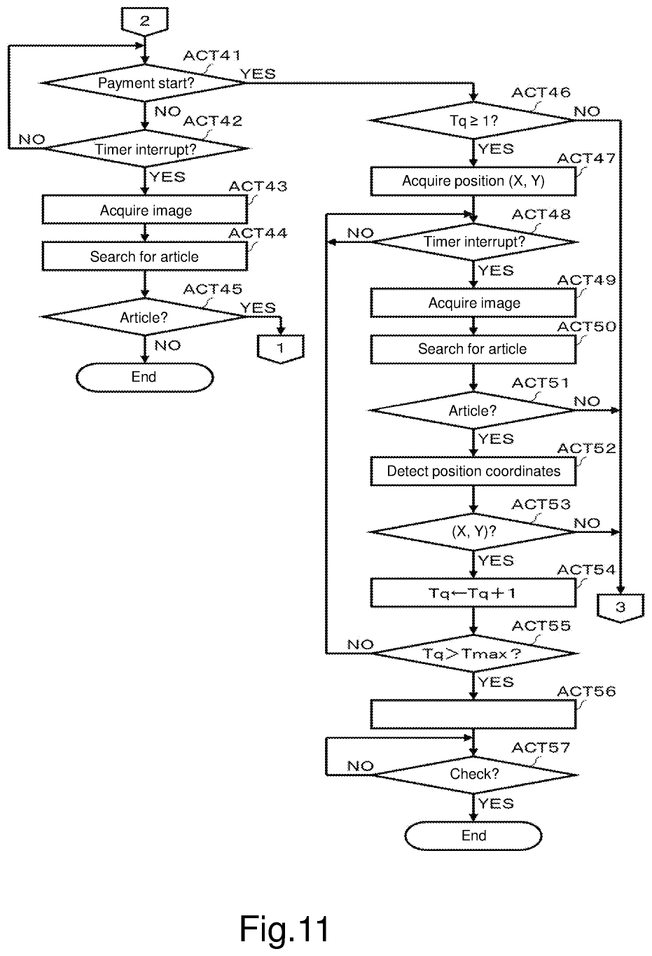

In the case where a record including the standing time “Tp” that has exceeded the threshold value Tmax has not been stored in the first table 522 (NO in ACT33), the processing of the processor 51 proceeds to ACT34. In ACT34, the processor 51 copies all the records of the first table 522 to the second table 523. When finishing the copying, the processor 51 clears the first table 522 in ACT35. After that, the processing of the processor 51 proceeds to ACT41 in FIG. 11.

In ACT41, the processor 51 checks whether or not a payment start signal has been received. In the case where a payment start signal has not been received (NO in ACT41), the processing of the processor 51 proceeds to ACT42. In ACT42, the processor 51 checks whether or not a timer interrupt signal has been received. In the case where a timer interrupt signal has not been received (NO in ACT42), the processing of the processor 51 returns to ACT41. In this way, the processor 51 stands by for receiving a payment start signal or a timer interrupt signal in ACT41 and ACT42.

When a timer interrupt signal is received in the stand-by state of ACT41 and ACT42 (YES in ACT42), the processing of the processor 51 proceeds to ACT43. In ACT43 to ACT45, the processor 51 executes the same processing as that in ACT14 to ACT16 shown in FIG. 9. That is, in ACT43, the processor 51 acquires the next image data from the image memory 521. In ACT44, the processor 51 analyzes the image data to search for an article placed on the first product placement table 102 or the second product placement table 103. In ACT45, the processor 51 determines whether or not an article has been detected.

In the case where an article has not been detected (NO in ACT45), e.g., the article “A” and the article “B” shown in FIG. 5 have been taken out from the first product placement table 102 and the second product placement table 103, the processing of the processor 51 finishes the information processing shown in the flowcharts of FIG. 9 to FIG. 11 and returns to the idle state.

Meanwhile, in the case where an article has been detected (YES in ACT45), e.g., the article A and the article B are still left on the first product placement table 102 and the second product placement table 103, the processing of the processor 51 returns to ACT21 in FIG. 10. The processor 51 executes the processing of ACT21 and subsequent ACTs similarly as described above. That is, in ACT21, the processor 51 stores the number of articles “N”. Further, the processor 51 assigns unique article IDs to the respective articles for the number of articles “N” in ACT22 and the central position coordinates in ACT23. Then, in ACT24, the processor 51 creates the first table 522 (see FIG. 4).

The processor 51 resets the addition counter value “n” to “0” in ACT25 and then counts up the addition counter value “n” by “1” in ACT26. Then, the processor 51 acquires the first record Rx from the first table 522 in ACT27 and searches the second table 523 (see FIG. 4) in ACT28.

This time, since the record of the first table 522 is copied to the second table 523 in the processing of ACT34, in the case where an article has been detected at the same position in both the image acquired last time and the image acquired this time, a record including position coordinates substantially matching the position coordinate of the first record Rx, i.e., the second record Ry, is stored in the second table 523.

In the case where the second record Ry has been stored in the second table 523 (YES in ACT29), the processing of the processor 51 proceeds to ACT31. In ACT31, the processor 51 detects a standing time “Tq” of the second record Ry. Then, in ACT32, the processor 51 adds the time obtained by adding “1” to the standing time “Tq” of the second record Ry to the standing time “Tq” of the first record Rx. As a result, for example, in the case where the standing time “Tp” and the standing time “Tq” are both “0”, the standing time “Tp” is “1”. After that, the processing of the processor 51 proceeds to ACT30. Then, in ACT30, the processor 51 determines whether or not the counter value “n” has exceeded the number of articles “N”.

Meanwhile, in the case where the second record Ry has not been stored in the second table 523 (NO in ACT29), the processing of the processor 51 proceeds to ACT30. Then, in ACT30, the processor 51 determines whether or not the counter value “n” has exceeded the number of articles “N”.

In the case where the counter value “n” has not exceeded the number of articles “N” (NO in ACT30), the processing of the processor 51 returns to ACT26. The processor 51 repeatedly executes the processing of ACT26 to ACT32 until the counter value “n” exceeds the number of articles “N”.

In this way, the standing time “Tp” of the first record Rx including the position coordinates substantially matching the position coordinates of the second record Ry is incremented by “1” in the case where the second record Ry is stored in the second table 523. The standing time “Tp” of the first record Rx including the position coordinates substantially matching the position coordinates of the second record Ry remains “0” in the case where the second record Ry is not stored in the second table 523.

When the counter value “n” has exceeded the number of articles “N”, the processor 51 checks whether or not a record including the standing time “Tp” that has exceeded the threshold value Tmax is stored in the first table 522 in ACT33. In the case where a record including the standing time “Tp” that has exceeded the threshold value Tmax has not been stored in the first table 522 (NO in ACT33), the processing of the processor 51 proceeds to ACT34. In ACT34, the processor 51 copies all the records of the first table 522 to the second table 523. Then, in ACT35, the processor 51 clears the first table 522. After that, the processor 51 enters the stand-by state of ACT41 and ACT42, i.e., stands by for receiving a payment start signal or a timer interrupt signal. In the case where a timer interrupt signal has been received again, the processor 51 executes the processing of ACT43 to ACT45 and executes, when an article has been detected, the processing of ACT21 to ACT35 similarly as described above.

In this way, when the processing of ACT21 to ACT35 and the processing of ACT41 to ACT45 are repeatedly executed without inputting a payment start signal, there is a possibility that a record including the standing time “Tp” that has exceeded the threshold value Tmax is detected from the first table 522.

In the case where a record including the standing time “Tp” that has exceeded the threshold value Tmax is detected from the first table 522 (YES in ACT33), the processing of the processor 51 proceeds to ACT36. In ACT36, the processor 51 performs a notifying operation. For example, the processor 51 outputs a notification signal to the attendant terminal 20 via the network interface 57.

The attendant terminal 20 that has received a notification signal displays an image 91 for notifying an attendant of that there is a lost article on the list of purchased products registered in the self-service POS terminal 10 to which the monitoring device 50 that is the output source of the notification signal is connected, as shown in FIG. 12. The attendant who has checked the image 91 moves to the checkout counter and collects the left article “A” and the left article “B”. After that, the attendant returns to the monitoring place and operates a [Check] button. When the [Check] button is operated, a check signal is output from the attendant terminal 20 to the monitoring device 50. Note that the attendant may collect the article after operating the [Check] button.

The processor 51 of the monitoring device 50 that has output a notification signal in ACT36 stands by for a check signal in ACT37. When a check signal is received from the attendant terminal 20 (YES in ACT37), the processor 51 finishes the information processing shown in the flowcharts of FIG. 9 to FIG. 11 and returns to the idle state.

The processor 51 executes the function of the reception unit 81 by the processing of ACT13, the function of the acquisition unit 82 by the processing of ACT14 and ACT43, the function of the detection unit 83 by the processing of ACT15 and ACT16 and the processing of ACT44 and ACT45, the function of the time measurement unit 84 by the processing of ACT27 to ACT32, and the function of the notification unit 85 by the processing of ACT33 and ACT36.

In this way, when a payer who has finished the payment by the self-service POS terminal 10 leaves the place while an article is left on the first product placement table 102 or the second product placement table 103, an attendant is notified of that there is a lost article. Therefore, the attendant can monitor, in the monitoring place, the occurrence of a lost article left on the self-service POS terminal 10. In the case where the attendant has found a lost article, he/she can promptly collect the lost article, which allows to eliminate the situation where the next customer cannot operate the self-service POS terminal 10 because there is a lost article, as much as possible.

Incidentally, on the self-service POS terminal 10 where the previous customer has finished the payment, the payment start screen is displayed regardless of whether or not an article is left. Therefore, the next customer starts payment in some cases before an attendant collects the article. When the next customer touches the start key of the payment start screen, the operation input data relating to payment start, i.e., the payment start signal, is input from the self-service POS terminal 10 to the terminal interface 56. At this time, the processor 51 of the monitoring device 50 in in the stand-by state of ACT41 and ACT42 in FIG. 11.

When a payment start signal is received in the stand-by state of ACT41 and ACT42 (YES in ACT41), the processing of the processor 51 proceeds from ACT41 to ACT46. In ACT46, the processor 51 checks whether or not a record including the standing time “Tq” of “1” or more is stored in the second table 523. The record including the standing time “Tq” of “1” or more is a record relating to an article left on the first product placement table 102 or the second product placement table 103 before the next customer starts payment. Hereinafter, the record including the standing time “Tq” of “1” or more will be referred to as a third record Rz.

In the case where the third record Rz is not stored in the second table 523 (NO in ACT46), the processing of the processor 51 returns to ACT12 in FIG. 9. The processor 51 executes the processing of ACT12 and subsequent ACTs similarly as described above.

Meanwhile, in the case where the third record Rz is stored in the second table 523 (YES in ACT46), the processing of the processor 51 proceeds to ACT47. In ACT47, the processor 51 acquires the position coordinates (X, Y) of the third record Rz. Incidentally, in the case where a plurality of third records Rz is stored, the processor 51 acquires the position coordinates (X, Y) of each of the third records Rz.

In ACT48, the processor 51 stands by for a timer interrupt signal. When a timer interrupt signal is received (YES in ACT48), the processing of the processor 51 proceeds to ACT49. In ACT49 to ACT51, the processor 51 executes the same processing as the processing of ACT14 to ACT16 shown in FIG. 9. That is, in ACT49, the processor 51 acquires the next image data from the image memory 521. In ACT50, the processor 51 analyzes the image data to search for an article placed on the first product placement table 102 or the second product placement table 103. In ACT51, the processor 51 determines whether or not an article has been detected. In the case where an article has been detected (NO in ACT51), the processing of the processor 51 returns to ACT12 in FIG. 9. The processor 51 executes the processing of ACT12 and subsequent ACTs similarly as described above.

In the case where an article has been detected (YES in ACT51), the processor 51 proceeds to ACT52. In ACT52, the processor 51 detects the central position coordinates of the detected article similarly to the processing of ACT23 in FIG. 10. Also at this time, in the case where a plurality of articles has been detected, the processor 51 detects the central position coordinates of each of the articles.

In ACT53, the processor 51 checks whether or not the position coordinates substantially matching the position coordinates (X, Y) of the third record Rz have been detected in the processing of ACT52. Also in this case, similarly to the processing of ACT29 in FIG. 10, the phrase “substantially matching” means a case where the length of the line segment connecting a first point specified by one position coordinates and a second point specified by the other position coordinates is equal to or less than a predetermined distance.

In the case where the position coordinates substantially matching the position coordinates (X, Y) of the third record Rz have not been detected in the processing of ACT52 (NO in ACT53), the processing of the processor 51 returns to ACT12 in FIG. 9. The processor 51 executes the processing of ACT12 and subsequent ACTs similarly as described above.

In the case where the position coordinates substantially matching the position coordinates (X, Y) of the third record Rz have been detected in the processing of ACT52 (YES in ACT53), the processing of the processor 51 proceeds to ACT54. In ACT54, the processor 51 adds “1” to the standing times “Tq” of all the third records Rz, the position coordinates substantially matching the position coordinates of the third record Rz having been detected.

In ACT55, the processor 51 checks whether or not the standing time “Tq” has exceeds the threshold value Tmax. In the case where the standing time “Tq” has not exceeded the threshold value Tmax (NO in ACT55), the processing of the processor 51 returns to ACT48. The processor 51 executes the processing of ACT48 and subsequent ACTs similarly as described above. That is, the processor 51 acquires, when a timer interrupt signal is received, the next image data from the image memory 521 in ACT49, and analyzes the image data to search for an article placed on the first product placement table 102 or the second product placement table 103 in ACT50. As a result, when an article has been detected, the processor 51 detects the central position coordinates of the detected article in ACT52, and checks whether or not position coordinates substantially matching the position coordinates (X, Y) of the third record Rz have been detected in ACT53. In the case where the position coordinates substantially matching the position coordinates (X, Y) of the third record Rz have been detected, the processor 51 adds “1” to the standing times “Tq” of all the third records Rz, the position coordinates substantially matching the position coordinates of the third record Rz having been detected, in ACT54.

In this way, in the case where the standing time “Tq” has exceeded the threshold value Tmax (YES in ACT55), the processing of the processor 51 proceeds to ACT56. In ACT56, similarly to the processing of ACT36 in FIG. 9, the processor 51 performs a notifying operation. When a check signal is received from the attendant terminal 20 (YES in ACT56), the processor 51 finishes the information processing shown in the flowcharts of FIG. 9 to FIG. 11 and returns to the idle state.

The processor 51 executes the function of the reception unit 81 by the processing of ACT41, the function of the acquisition unit 82 by the processing of ACT49, the function of the detection unit 83 by the processing of ACT50 to ACT51, the function of the time measurement unit 84 by the processing of ACT47 and ACT52 to ACT54, and the function of the notification unit 85 by the processing of ACT55 and ACT56.

In this way, even in the case where the next customer starts the payment before an attendant collects the article left on the first product placement table 102 or the second product placement table 103, the attendant is notified of that there is a lost article when the standing time “Tq” of the article exceeds the threshold value Tmax. Therefore, since the attendant collects the left article, there is no problem if the next customer operates the self-service POS terminal 10 to start the payment.

[Modification]

In the embodiment described above, a case where each of the self-service POS terminals 10 includes the monitoring device 50 has been illustrated. In another embodiment, one monitoring device 50 is connected to two or more self-service POS terminals 10 and the camera 60 installed in the vicinity of each of the self-service POS terminals 10 and the occurrence of a lost article can be monitored in the two or more self-service POS terminals 10.

In the embodiment described above, the monitoring device 50 has been described as a device that has a function of monitoring a fraudulent action of a payer and the occurrence of a lost article. The monitoring device 50 may be specialized in the function of monitoring the occurrence of a lost article. However, in the case where the monitoring device 50 has the function of monitoring a fraudulent action of a payer and the occurrence of a lost article, the monitoring device 50 uses an image taken by one camera 60 for monitoring a fraudulent action during payment and for monitoring a lost article after the payment. Therefore, it is possible to effectively use resources.

In the embodiment described above, the fraudulent action monitoring program has been illustrated as an application program for the processor 51 to realize the fraudulent action monitoring function 511, and the lost article monitoring program has been illustrated as an application program for the processor 51 to realize the lost article monitoring function 512. In this regard, the processor 51 may realize the fraudulent action monitoring function 511 and the lost article monitoring function 512 by a common application program.

In the embodiment described above, the first product placement table 102 and the second product placement table 103 of the self-service POS terminal 10 have been used as the placement portions. The placement portion is not limited thereto. For example, In the case where the body 101 has a space for placing an article, the space may be included in the placement portion.

In the embodiment described above, the central position coordinates of an article have been detected in the processing of ACT23 in FIG. 10 and ACT52 in FIG. 11. In this regard, position coordinates of an article other than the center may be detected. The point is that whether or not an article is moving only needs to be determined.

In the embodiment described above, a common threshold value Tmax has been used to be compared with the standing time “Tp” or the standing time “Tq” in the processing of ACT33 in FIG. 10 and ACT55 in FIG. 11. In this regard, for example, in ACT55 in FIG. 11, a first threshold value Tmax to be compared with the standing time “Tq” may be a value smaller than a second threshold value Tmax to be compared with the standing time “Tp” in ACT33 in FIG. 10. An article placed on the first product placement table 102 or the second product placement table 103 when the next customer starts payment is likely to be a left article. For this reason, by making the first threshold value Tmax smaller than the second threshold value Tmax, it is possible to make the timing when the left article is set as a lost article earlier. It goes without saying that the first threshold value Tmax may be larger than the second threshold value Tmax.

In the embodiment described above, a case where the image 91 for notifying an attendant of that there is a lost article is displayed on the list of purchased products in the attendant terminal 20 that has received a notification signal has been illustrated. In another embodiment, information for specifying whether a lost article is placed on the first product placement table 102 or on the second product placement table 103 may be displayed together. Further, the detection unit 83 is capable of specifying whether a left article is a product or a shopping basket by using an existing technology. In this regard, the type of the left article may be displayed together. Further, since the image of the left article is stored in the image memory 521, the image may be displayed. By displaying the image, an attendant can find a lost article more reliably. Although some embodiments of the payment system 100 that includes the monitoring device 50 capable of monitoring the occurrence of a lost article in the full self-service POS terminal 10 have been described, such embodiments are not limited thereto.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A monitoring device that monitors a payment apparatus including a placement portion for placing a purchased product, comprising:
a camera interface that is connected to a camera and captures image data of an image taken by the camera, the camera imaging an imaging area including the placement portion;
an image memory that stores the image data captured by the camera interface in chronological order; and
a processor configured to
acquire the image data stored in the image memory,
detect an article placed on the placement portion on a basis of the acquired image data,
measure a time period during which the detected article is left in the same place, and
notify, where the measured time period exceeds a threshold value, that there is a lost article in the placement portion.

2. The monitoring device according to claim 1, further comprising
a terminal interface that is connected to the payment terminal and receives a payment end signal for notifying payment end of the purchased product from the payment apparatus.

3. The monitoring device according to claim 2, wherein
the processor is further configured to start an operation of detecting the article by using the payment end signal as a trigger.

4. The monitoring device according to claim 2, wherein
the terminal interface further receives a payment start signal for notifying payment start of the purchased product from the payment apparatus.

5. The monitoring device according to claim 2, wherein
the processor is further configured to stop, where the article has not been detected at a time point when the payment start signal was received, the operation of detecting the article.

6. The monitoring device according to claim 3, wherein
the processor is further configured to continue, where the article has been detected at a time point when the payment start signal was received, the operation of detecting the article.

7. The monitoring device according to claim 3, wherein
the processor is further configured to measure a time period during which an article detected immediately before receiving the payment start signal is left in the same place.

8. The monitoring device according to claim 3, wherein
the processor is further configured to measure a time period during which an article detected immediately before receiving the payment start signal is left in the same place and not to measure a time period for an article detected after receiving the payment start signal.

9. A payment system, comprising:
a payment apparatus that is operated by a customer to pay for a purchased product;
a camera that images an imaging area including a placement portion of the payment apparatus on which the purchased product is placed; and
a monitoring device that monitors presence or absence of a lost article on the placement portion, wherein
the monitoring device includes
a camera interface that is connected to a camera and captures image data of an image taken by the camera, the camera imaging an imaging area including the placement portion,
an image memory that stores the image data captured by the camera interface in chronological order, and
a processor configured to
acquire the image data stored in the image memory,
detect an article placed on the placement portion on a basis of the acquired image data,
measure a time period during which the detected article is left in the same place, and
notify, where the measured time period exceeds a threshold value, that there is a lost article in the placement portion.

10. A control method for a monitoring device that monitors a payment apparatus including a placement portion for placing a purchased product, comprising:
imaging, by a camera, an imaging area including the placement portion;
storing, in an image memory, image data of an image taken by the camera in chronological order;
acquiring the image data stored in the image memory;
detecting an article placed on the placement portion on a basis of the acquired image data;
measuring a time period during which the detected article is left in the same place; and
notifying, where the measured time period exceeds a threshold value, that there is a lost article in the placement portion.
